(19) United States
(12) Patent Application Publication
(10) Pub. No.: US 2018/0220289 A1
(43) Pub. Date: Aug. 2, 2018

(54) METHOD FOR MANAGING PLURALITY OF LOCATION AREAS IN WIRELESS COMMUNICATION SYSTEM AND APPARATUS THEREFOR

(71) Applicant: LG ELECTRONICS INC., Seoul (KR)

(72) Inventors: Jinsook RYU, Seoul (KR); Hyunsook KIM, Seoul (KR); Laeyoung KIM, Seoul (KR)

(21) Appl. No.: 15/748,076

(22) PCT Filed: Jul. 28, 2016
(86) PCT No.: PCT/KR2016/008318

§ 371 Date: Jan. 26, 2018

Related U.S. Application Data
(60) Provisional application No. 62/197,600, filed on Jul. 28, 2015.

(51) Int. Cl. H04W 8/04; H04W 8/08; H04W 4/02

(52) U.S. Cl. CPC H04W 8/04; H04W 4/02; H04W 8/08

(57) ABSTRACT

Disclosed are a method for managing a plurality of location areas in a wireless communication system and an apparatus therefor. Specifically, a method for performing, by a terminal, a location area update in a wireless communication system comprises the steps of: receiving, from a base station, respective tracking area codes (TAC) for multiple types of tracking areas (TA); determining whether a tracking area identity (TAI) comprising a TAC of anyone type of TA selected from the multiple types of TAs belongs to a TAI list of the terminal; and, if the TAI does not belong to the TAI list, performing a tracking area update (TAU) procedure.

### CROSS-REFERENCE TO RELATED APPLICATIONS

This application is the National Stage filing under 35 U.S.C. 371 of International Application No. PCT/KR2016/008318, filed on Jul. 28, 2016, which claims the benefit of U.S. Provisional Application No. 62/197,600, filed on Jul. 28, 2015, the contents of which are all hereby incorporated by reference herein in their entirety.

### TECHNICAL FIELD

The present invention relates to a wireless communication system, and more particularly, to a method for managing a plurality of paging areas/location areas and an apparatus for supporting the same.

### BACKGROUND ART

Mobile communication systems have been developed to provide voice services, while guaranteeing user activity. Service coverage of mobile communication systems, however, has extended even to data services, as well as voice services, and currently, an explosive increase in traffic has resulted in shortage of resource and user demand for a high speed services, requiring advanced mobile communication systems.

The requirements of the next-generation mobile communication system may include supporting huge data traffic, a remarkable increase in the transfer rate of each user, the accommodation of a significantly increased number of connection devices, very low end-to-end latency, and high energy efficiency. To this end, various techniques, such as small cell enhancement, dual connectivity, massive Multiple Input Multiple Output (MIMO), in-band full duplex, non-orthogonal multiple access (NOMA), supporting super-wide band, and device networking, have been researched.

### DISCLOSURE

### Technical Problem

An embodiment of the present invention provides a method for managing a paging area for efficient paging transmission to a terminal, in particular, a terminal (e.g., cellular Internet of things (CIoT)) having a no mobility/low mobility feature.

Furthermore, an embodiment of the present invention is to propose a method for managing an efficient paging area/location area considering all terminals having no mobility/low mobility and normal mobility features.

The technical problems solved by the present invention are not limited to the above technical problems and those skilled in the art may understand other technical problems from the following description.

### TECHNICAL SOLUTION

According to an aspect of the present invention, a method for performing, by a terminal, a location area update in a wireless communication system may include: receiving, from a base station, respective tracking area codes (TAC) for multiple types of tracking areas (TA); determining whether a tracking area identity (TAI) comprising a TAC of anyone type of TA selected from the multiple types of TAs belongs to a TAI list of the terminal; and, if the TAI does not belong to the TAI list, performing a tracking area update (TAU) procedure.

According to another aspect of the present invention, a terminal for performing location area update in a wireless communication system may include: a communication module for transmitting/receiving a signal; and a processor controlling the communication module, and the processor may be configured to receive, from a base station, respective tracking area codes (TAC) for multiple types of tracking areas (TA), determine whether a tracking area identity (TAI) comprising a TAC of anyone type of TA selected from the multiple types of TAs belongs to a TAI list of the terminal, and if the TAI does not belong to the TAI list, perform a tracking area update (TAU) procedure.

Preferably, the multiple types of TAs may include a first TA comprising a plurality of cells and a second TA which is in a relatively smaller range than the first TA.

Preferably, TA configuration information indicating which type of TA among the multiple types of TAs the terminal is to use may be stored in a home subscriber server (HSS).

Preferably, TA configuration information indicating which type of TA among the multiple types of TAs to use may be received from a mobility management entity (MME) during an attach procedure and/or a location area update procedure.

Preferably, the respective TAC for the multiple types of TAs may be broadcasted from the base station.

Preferably, a tracking area update (TAU) request message including a TAI for identifying the selected one type of TA, which is most recently visited by the terminal may be transmitted to the mobility management entity (MME).

Preferably, a tracking area update (TAU) accept message including a list of TAIs for identifying the selected one type of TA, which the terminal is capable of entering without performing the TAU procedure may be received from the mobility management entity (MME).

Preferably, when downlink data to be transmitted to the terminal is generated, a paging message may be transmitted to each base station which belongs to the selected one type of TA in which the terminal is registered.

### Advantageous Effects

The present invention has an advantage in that by configuring different types of location areas according to mobility characteristics of a terminal, a frequent location area update procedure of a terminal, particularly, a terminal (for example, a CIoT terminal) having a low mobility/low mobility feature can be prevented from being performed.

The present invention has an advantage in that by configuring different types of location areas according to mobility characteristics of a terminal, paging resources can be reduced.

Further, according to the embodiment of the present invention, when the paging is transmitted to the terminal, particularly, the terminal having the no mobility/low mobility feature, in the case where paging resources are insufficient, the paging resource can be saved by minimizing the paging area.

It will be appreciated by persons skilled in the art that that the effects that can be achieved through the present invention are not limited to what has been particularly described hereinabove and other advantages of the present invention will be more clearly understood from the following detailed description.

### DESCRIPTION OF DRAWINGS

The accompanying drawings, which are included to provide a further understanding of the present invention and constitute a part of specifications of the present invention, illustrate embodiments of the present invention and together with the corresponding descriptions serve to explain the principles of the present invention.

FIG. 1 is a diagram schematically exemplifying an evolved packet system (EPS) to which the present invention can be applied.

FIG. 2 illustrates an example of evolved universal terrestrial radio access network structure to which the present invention can be applied.

FIG. 3 exemplifies a structure of E-UTRAN and EPC in a wireless communication system to which the present invention can be applied.

FIG. 4 illustrates a structure of a radio interface protocol between a UE and E-UTRAN in a wireless communication system to which the present invention can be applied.

FIG. 5 is a diagram schematically showing a structure of a physical channel in a wireless communication system to which the present invention may be applied.

FIG. 6 is a diagram for describing a contention based random access procedure in a wireless communication system to which the present invention may be applied.

FIG. 7 illustrates an architecture for service capability exposure in a wireless communication system to which the present invention may be applied.

FIG. 8 illustrates an architecture for service capability exposure in a wireless communication system to which the present invention may be applied.

FIG. 9 is a diagram showing a tracking area identifier in a wireless communication system to which the present invention may be applied.

FIG. 10 is a diagram showing an S1 setup process in a wireless communication system to which the present invention may be applied.

FIG. 11 is a diagram showing a multi-type tracking area according to an embodiment of the present invention.

FIG. 12 is a diagram showing a tracking area setup procedure according to an embodiment of the present invention.

FIG. 13 is a diagram showing a location area update procedure according to an embodiment of the present invention.

FIG. 14 illustrates a block diagram of a communication apparatus procedure according to an embodiment of the present invention.

FIG. 15 illustrates a block diagram of a communication apparatus procedure according to an embodiment of the present invention.

### MODE FOR INVENTION

In what follows, preferred embodiments according to the present invention will be described in detail with reference to appended drawings. The detailed descriptions provided below together with appended drawings are intended only to explain illustrative embodiments of the present invention, which should not be regarded as the sole embodiments of the present invention. The detailed descriptions below include specific information to provide complete understanding of the present invention. However, those skilled in the art will be able to comprehend that the present invention can be embodied without the specific information.

For some cases, to avoid obscuring the technical principles of the present invention, structures and devices well-known to the public can be omitted or can be illustrated in the form of block diagrams utilizing fundamental functions of the structures and the devices.

A base station in this document is regarded as a terminal node of a network, which performs communication directly with a UE. In this document, particular operations regarded to be performed by the base station may be performed by a upper node of the base station depending on situations. In other words, it is apparent that in a network consisting of a plurality of network nodes including a base station, various operations performed for communication with a UE can be performed by the base station or by network nodes other than the base station. The term Base Station (BS) can be replaced with a fixed station, Node B, evolved-NodeB (eNB), Base Transceiver System (BTS), or Access Point (AP). Also, a terminal can be fixed or mobile; and the term can be replaced with User Equipment (UE), Mobile Station (MS), User Terminal (UT), Mobile Subscriber Station (MSS), Subscriber Station (SS), Advanced Mobile Station (AMS), Wireless Terminal (WT), Machine-Type Communication (MTC) device, Machine-to-Machine (M2M) device, or Device-to-Device (D2D) device.

In what follows, downlink (DL) refers to communication from a base station to a terminal, while uplink (UL) refers to communication from a terminal to a base station. In downlink transmission, a transmitter can be part of the base station, and a receiver can be part of the terminal. Similarly, in uplink transmission, a transmitter can be part of the terminal, and a receiver can be part of the base station.

Specific terms used in the following descriptions are introduced to help understanding the present invention, and the specific terms can be used in different ways as long as it does not leave the technical scope of the present invention.

The technology described below can be used for various types of wireless access systems based on Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), or Non-Orthogonal Multiple Access (NOMA). CDMA can be implemented by such radio technology as Universal Terrestrial Radio Access (UTRA) or CDMA2000. TDMA can be implemented by such radio technology as Global System for Mobile communications (GSM), General Packet Radio Service (GPRS), or Enhanced Data rates for GSM Evolution (EDGE). OFDMA can be implemented by such radio technology as the IEEE 802.11 (Wi-Fi), the IEEE 802.16 (WiMAX), the IEEE 802-20, or Evolved UTRA (E-UTRA). UTRA is part of the Universal Mobile Telecommunications System (UMTS). The 3rd Generation Partnership Project (3GPP) Long Term Evolution (LTE) is part of the Evolved UMTS (E-UMTS) which uses the E-UTRA, employing OFDMA for downlink and SC-FDMA for uplink transmission. The LTE-A (Advanced) is an evolved version of the 3GPP LTE system.

Embodiments of the present invention can be supported by standard documents disclosed in at least one of wireless access systems including the IEEE 802, 3GPP, and 3GPP2 specifications. In other words, among the embodiments of the present invention, those steps or parts omitted for the purpose of clearly describing technical principles of the present invention can be supported by the documents above. Also, all of the terms disclosed in this document can be explained with reference to the standard documents.

To clarify the descriptions, this document is based on the 3GPP LTE/LTE-A, but the technical features of the present invention are not limited to the current descriptions.

Terms used in this document are defined as follows.

Universal Mobile Telecommunication System (UMTS): the 3rd generation mobile communication technology based on GSM, developed by the 3GPP

Evolved Packet System (EPS): a network system comprising an Evolved Packet Core (EPC), a packet switched core network based on the Internet Protocol (IP) and an access network such as the LTE and UTRAN. The EPS is a network evolved from the UMTS.

NodeB: the base station of the UMTS network. NodeB is installed outside and provides coverage of a macro cell.

eNodeB: the base station of the EPS network. eNodeB is installed outside and provides coverage of a macro cell.

User Equipment (UE): A UE can be called a terminal, Mobile Equipment (ME), or Mobile Station (MS). A UE can be a portable device such as a notebook computer, mobile phone, Personal Digital Assistant (PDA), smart phone, or a multimedia device; or a fixed device such as a Personal Computer (PC) or vehicle-mounted device. The term UE may refer to an MTC terminal in the description related to MTC.

IP Multimedia Subsystem (IMS): a sub-system providing multimedia services based on the IP

International Mobile Subscriber Identity (IMSI): a globally unique subscriber identifier assigned in a mobile communication network

Machine Type Communication (MTC): communication performed by machines without human intervention. It may be called Machine-to-Machine (M2M) communication.

MTC terminal (MTC UE or MTC device): a terminal (for example, a vending machine, meter, and so on) equipped with a communication function operating through a mobile communication network(For example, communicating with an MTC server via a PLMN) and performing an MTC function

MTC server: a server on a network managing MTC terminals. It can be installed inside or outside a mobile communication network. It can provide an interface through which an MTC user can access the server. Also, an MTC server can provide MTC-related services to other servers (in the form of Services Capability Server (SCS)) or the MTC server itself can be an MTC Application Server.

(MTC) application: services (to which MTC is applied) (for example, remote metering, traffic movement tracking, weather observation sensors, and so on)

(MTC) Application Server: a server on a network in which (MTC) applications are performed

MTC feature: a function of a network to support MTC applications. For example, MTC monitoring is a feature intended to prepare for loss of a device in an MTC application such as remote metering, and low mobility is a feature intended for an MTC application with respect to an MTC terminal such as a vending machine.

MTC User (MTC User): The MTC user uses the service provided by the MTC server.

MTC subscriber: an entity having a connection relationship with a network operator and providing services to one or more MTC terminals.

MTC group: an MTC group shares at least one or more MTC features and denotes a group of MTC terminals belonging to MTC subscribers.

Services Capability Server (SCS): an entity being connected to the 3GPP network and used for communicating with an MTC InterWorking Function (MTC-IWF) on a Home PLMN (HPLMN) and an MTC terminal. The SCS provides the capability for use by one or more MTC applications.

External identifier: a globally unique identifier used by an external entity (for example, an SCS or an Application Server) of the 3GPP network to indicate (or identify) an MTC terminal (or a subscriber to which the MTC terminal belongs). An external identifier comprises a domain identifier and a local identifier as described below.

Domain identifier: an identifier used for identifying a domain in the control region of a mobile communication network service provider. A service provider can use a separate domain identifier for each service to provide an access to a different service.

Local identifier: an identifier used for deriving or obtaining an International Mobile Subscriber Identity (IMSI). A local identifier should be unique within an application domain and is managed by a mobile communication network service provider.

Radio Access Network (RAN): a unit including a Node B, a Radio Network Controller (RNC) controlling the Node B, and an eNodeB in the 3GPP network. The RAN is defined at the terminal level and provides a connection to a core network.

Home Location Register (HLR)/Home Subscriber Server (HSS): a database provisioning subscriber information within the 3GPP network. An HSS can perform functions of configuration storage, identity management, user state storage, and so on.

RAN Application Part (RANAP): an interface between the RAN and a node in charge of controlling a core network (in other words, a Mobility Management Entity (MME)/Serving GPRS (General Packet Radio Service) Supporting Node (SGSN)/Mobile Switching Center (MSC)).

Public Land Mobile Network (PLMN): a network formed to provide mobile communication services to individuals. The PLMN can be formed separately for each operator.

Non-Access Stratum (NAS): a functional layer for exchanging signals and traffic messages between a terminal and a core network at the UMTS and EPS protocol stack. The NAS is used primarily for supporting mobility of a terminal and a session management procedure for establishing and maintaining an IP connection between the terminal and a PDN GW.

Service Capability Exposure Function (SCEF): An entity within the 3GPP architecture for service capability exposure that provides a means for securely exposing services and capabilities provided by 3GPP network interfaces.

In what follows, the present invention will be described based on the terms defined above.

Overview of System to Which the Present Invention May be Applied

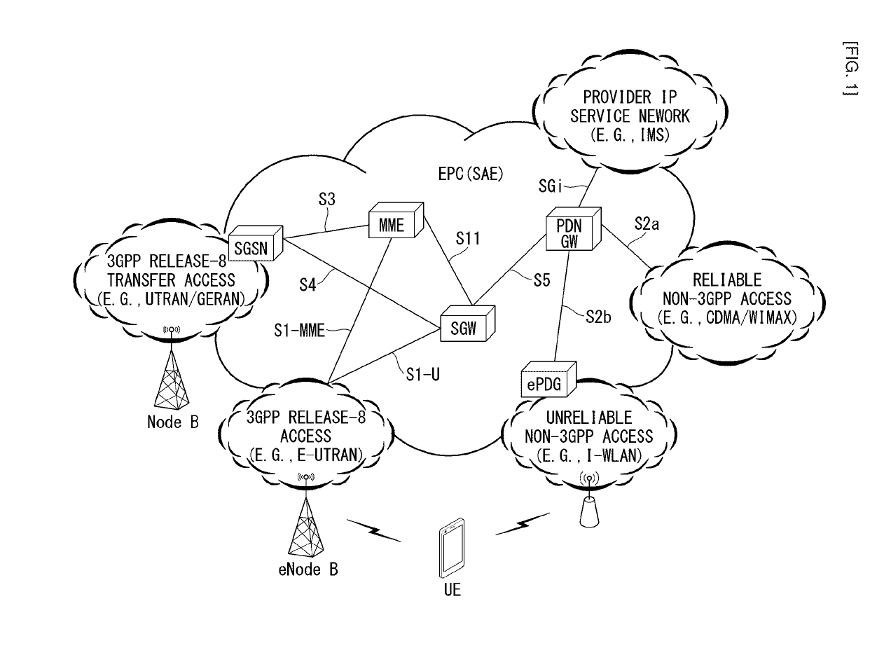

FIG. 1 illustrates an Evolved Packet System (EPS) to which the present invention can be applied.

The network structure of FIG. 1 is a simplified diagram restructured from an Evolved Packet System (EPS) including Evolved Packet Core (EPC).

The EPC is a main component of the System Architecture Evolution (SAE) intended for improving performance of the 3GPP technologies. SAE is a research project for determining a network structure supporting mobility between multiple heterogeneous networks. For example, SAE is intended to provide an optimized packet-based system which supports various IP-based wireless access technologies, provides much more improved data transmission capability, and so on.

More specifically, the EPC is the core network of an IP-based mobile communication system for the 3GPP LTE system and capable of supporting packet-based real-time and non-real time services. In the existing mobile communication systems (namely, in the 2nd or 3rd mobile communication system), functions of the core network have been implemented through two separate sub-domains: a Circuit-Switched (CS) sub-domain for voice and a Packet-Switched (PS) sub-domain for data. However, in the 3GPP LTE system, an evolution from the 3rd mobile communication system, the CS and PS sub-domains have been unified into a single IP domain. In other words, in the 3GPP LTE system, connection between UEs having IP capabilities can be established through an IP-based base station (for example, eNodeB), EPC, and application domain (for example, IMS). In other words, the EPC provides the architecture essential for implementing end-to-end IP services.

The EPC comprises various components, where FIG. 1 illustrates part of the EPC components, including a Serving Gateway (SGW or S-GW), Packet Data Network Gateway (PDN GW or PGW or P-GW), Mobility Management Entity (MME), Serving GPRS Supporting Node (SGSN), and enhanced Packet Data Gateway (ePDG).

The SGW operates as a boundary point between the Radio Access Network (RAN) and the core network and maintains a data path between the eNodeB and the PDN GW. Also, in case the UE moves across serving areas by the eNodeB, the SGW acts as an anchor point for local mobility. In other words, packets can be routed through the SGW to ensure mobility within the E-UTRAN (Evolved-UMTS (Universal Mobile Telecommunications System) Terrestrial Radio Access Network defined for the subsequent versions of the 3GPP release 8). Also, the SGW may act as an anchor point for mobility between the E-UTRAN and other 3GPP networks (the RAN defined before the 3GPP release 8, for example, UTRAN or GERAN (GSM (Global System for Mobile Communication)/EDGE (Enhanced Data rates for Global Evolution) Radio Access Network).

The PDN GW corresponds to a termination point of a data interface to a packet data network. The PDN GW can support policy enforcement features, packet filtering, charging support, and so on. Also, the PDN GW can act as an anchor point for mobility management between the 3GPP network and non-3GPP networks (for example, an unreliable network such as the Interworking Wireless Local Area Network (I-WLAN) or reliable networks such as the Code Division Multiple Access (CDMA) network and WiMax).

In the example of a network structure as shown in FIG. 1, the SGW and the PDN GW are treated as separate gateways; however, the two gateways can be implemented according to single gateway configuration option.

The MME performs signaling for the UE's access to the network, supporting allocation, tracking, paging, roaming, handover of network resources, and so on; and control functions. The MME controls control plane functions related to subscribers and session management. The MME manages a plurality of eNodeBs and performs signaling of the conventional gateway's selection for handover to other 2G/3G networks. Also, the MME performs such functions as security procedures, terminal-to-network session handling, idle terminal location management, and so on.

The SGSN deals with all kinds of packet data including the packet data for mobility management and authentication of the user with respect to other 3GPP networks (for example, the GPRS network).

The ePDG acts as a security node with respect to an unreliable, non-3GPP network (for example, I-WLAN, WiFi hotspot, and so on).

As described with respect to FIG. 1, a UE with the IP capability can access the IP service network (for example, the IMS) that a service provider (namely, an operator) provides, via various components within the EPC based not only on the 3GPP access but also on the non-3GPP access.

Also, FIG. 1 illustrates various reference points (for example, S1-U, S1-MME, and so on). The 3GPP system defines a reference point as a conceptual link which connects two functions defined in disparate functional entities of the E-UTAN and the EPC. Table 1 below summarizes reference points shown in FIG. 1. In addition to the examples of FIG. 1, various other reference points can be defined according to network structures.

TABLE 1

| Refer- | |
|---|---|
| ence | |
| point | Description |
| S1- | Reference point for the control plane protocol between |
| MME | E-UTRAN and MME |
| S1-U | Reference point between E-UTRAN and Serving GW for the per |
| | bearer user plane tunneling and inter eNodeB path switching |
| | during handover |
| S3 | It enables user and bearer information exchange for inter 3GPP |
| | access network mobility in idle and/or active state. This |
| | reference point can be used intra-PLMN or inter-PLMN (e.g. in |
| | the case of Inter-PLMN HO). |
| S4 | It provides related control and mobility support between GPRS |
| | core and the 3GPP anchor function of Serving GW. In addition, |
| | if direct tunnel is not established, it provides the user |
| | plane tunneling. |
| S5 | It provides user plane tunneling and tunnel management between |
| | Serving GW and PDN GW. It is used for Serving GW relocation |
| | due to UE mobility if the Serving GW needs to connect to a non- |
| | collocated PDN GW for the required PDN connectivity. |
| S11 | Reference point for the control plane protocol between MME |
| | and SGW |
| SGi | It is the reference point between the PDN GW and the packet |
| | data network. Packet data network may be an operator external |
| | public or private packet data network or an intra-operator packet |
| | data network (e.g., for provision of IMS services). This |
| | reference point corresponds to Gi for 3GPP accesses. |

Among the reference points shown in FIG. 1, S2a and S2b corresponds to non-3GPP interfaces. S2a is a reference point which provides reliable, non-3GPP access, related control between PDN GWs, and mobility resources to the user plane. S2b is a reference point which provides related control and mobility resources to the user plane between ePDG and PDN GW.

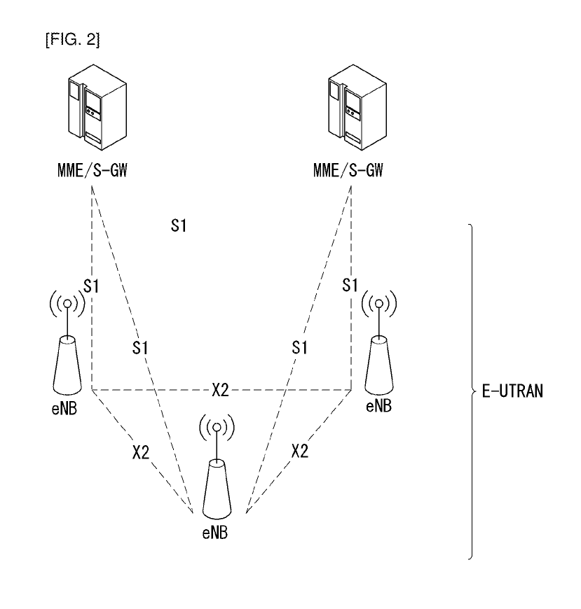

FIG. 2 illustrates one example of an Evolved Universal Terrestrial Radio Access Network (E-UTRAN) to which the present invention can be applied.

The E-UTRAN system is an evolved version of the existing UTRAN system, for example, and is also referred to as 3GPP LTE/LTE-A system. Communication network is widely deployed in order to provide various communication services such as voice (e.g., Voice over Internet Protocol (VoIP)) through IMS and packet data.

Referring to FIG. 2, E-UMTS network includes E-UTRAN, EPC and one or more UEs. The E-UTRAN includes eNBs that provide control plane and user plane protocol, and the eNBs are interconnected with each other by means of the X2 interface.

The X2 user plane interface (X2-U) is defined among the eNBs. The X2-U interface provides non-guaranteed delivery of the user plane Packet Data Unit (PDU). The X2 control plane interface (X2-CP) is defined between two neighboring eNBs. The X2-CP performs the functions of context delivery between eNBs, control of user plane tunnel between a source eNB and a target eNB, delivery of handover-related messages, uplink load management, and so on.

The eNB is connected to the UE through a radio interface and is connected to the Evolved Packet Core (EPC) through the S1 interface.

The S1 user plane interface (S1-U) is defined between the eNB and the Serving Gateway (S-GW). The Si control plane interface (S1-MME) is defined between the eNB and the Mobility Management Entity (MME). The S1 interface performs the functions of EPS bearer service management, non-access stratum (NAS) signaling transport, network sharing, MME load balancing management, and so on. The S1 interface supports many-to-many-relation between the eNB and the MME/S-GW.

The MME may perform various functions such as NAS signaling security, Access Stratum (AS) security control, Core Network (CN) inter-node signaling for supporting mobility between 3GPP access network, IDLE mode UE reachability (including performing paging retransmission and control), Tracking Area Identity (TAI) management (for UEs in idle and active mode), selecting PDN GW and SGW, selecting MME for handover of which the MME is changed, selecting SGSN for handover to 2G or 3G 3GPP access network, roaming, authentication, bearer management function including dedicated bearer establishment, Public Warning System (PWS) (including Earthquake and Tsunami Warning System (ETWS) and Commercial Mobile Alert System (CMAS), supporting message transmission and so on.

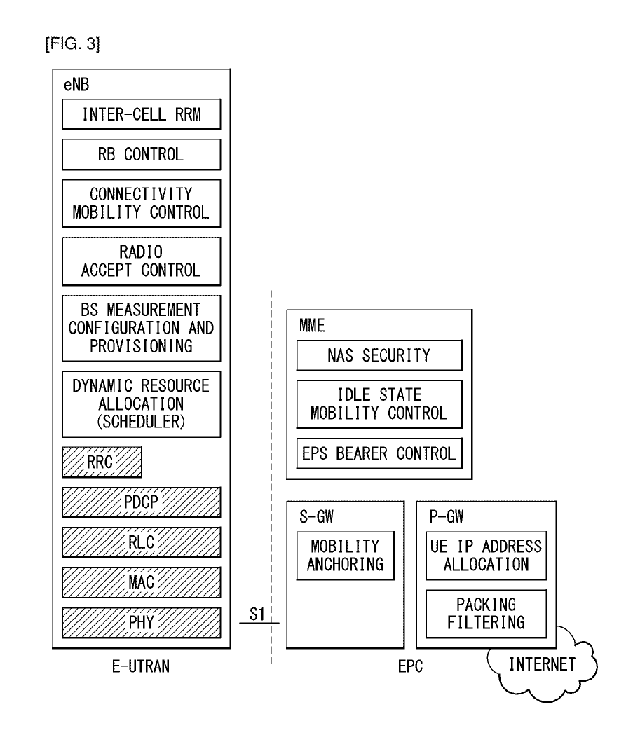

FIG. 3 exemplifies a structure of E-UTRAN and EPC in a wireless communication system to which the present invention can be applied.

Referring to FIG. 3, an eNB may perform functions of selecting gateway (e.g., MME), routing to gateway during radio resource control (RRC) is activated, scheduling and transmitting broadcast channel (BCH), dynamic resource allocation to UE in uplink and downlink, mobility control connection in LTE_ACTIVE state. As described above, the gateway in EPC may perform functions of paging origination, LTE_IDLE state management, ciphering of user plane, bearer control of System Architecture Evolution (SAE), ciphering of NAS signaling and integrity protection.

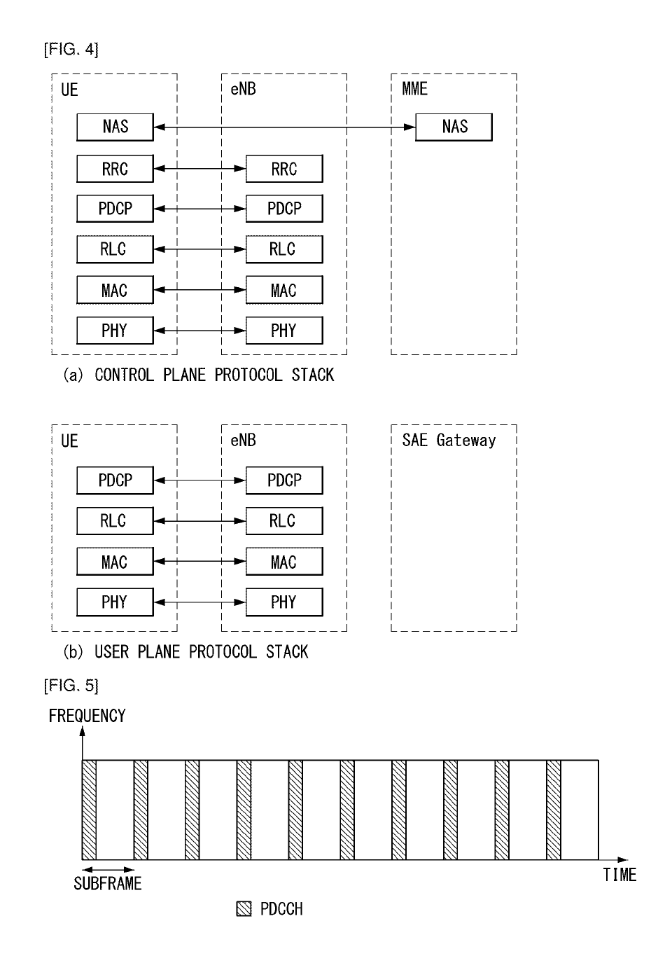

FIG. 4 illustrates a radio interface protocol structure between a UE and an E-UTRAN in a wireless communication system to which the present invention can be applied.

FIG. 4(a) illustrates a radio protocol structure for the control plane, and FIG. 4(b) illustrates a radio protocol structure for the user plane.

With reference to FIG. 4, layers of the radio interface protocol between the UE and the E-UTRAN can be divided into a first layer (L1), a second layer (L2), and a third layer (L3) based on the lower three layers of the Open System Interconnection (OSI) model, widely known in the technical field of communication systems. The radio interface protocol between the UE and the E-UTRAN consists of the physical layer, data link layer, and network layer in the horizontal direction, while in the vertical direction, the radio interface protocol consists of the user plane, which is a protocol stack for delivery of data information, and the control plane, which is a protocol stack for delivery of control signals.

The control plane acts as a path through which control messages used for the UE and the network to manage calls are transmitted. The user plane refers to the path through which the data generated in the application layer, for example, voice data, Internet packet data, and so on are transmitted. In what follows, described will be each layer of the control and the user plane of the radio protocol.

The physical layer (PHY), which is the first layer (L1), provides information transfer service to upper layers by using a physical channel. The physical layer is connected to the Medium Access Control (MAC) layer located at the upper level through a transport channel through which data are transmitted between the MAC layer and the physical layer. Transport channels are classified according to how and with which features data are transmitted through the radio interface. And data are transmitted through the physical channel between different physical layers and between the physical layer of a transmitter and the physical layer of a receiver. The physical layer is modulated according to the Orthogonal Frequency Division Multiplexing (OFDM) scheme and employs time and frequency as radio resources.

A few physical control channels are used in the physical layer. The Physical Downlink Control Channel (PDCCH) informs the UE of resource allocation of the Paging Channel (PCH) and the Downlink Shared Channel (DL-SCH); and Hybrid Automatic Repeat reQuest (HARQ) information related to the Uplink Shared Channel (UL-SCH). Also, the PDCCH can carry a UL grant used for informing the UE of resource allocation of uplink transmission. The Physical Control Format Indicator Channel (PCFICH) informs the UE of the number of OFDM symbols used by PDCCHs and is transmitted at each subframe. The Physical HARQ Indicator Channel (PHICH) carries a HARQ ACK (ACKnowledge)/NACK (Non-ACKnowledge) signal in response to uplink transmission. The Physical Uplink Control Channel (PUCCH) carries uplink control information such as HARQ ACK/NACK with respect to downlink transmission, scheduling request, Channel Quality Indicator (CQI), and so on. The Physical Uplink Shared Channel (PUSCH) carries the UL-SCH.

The MAC layer of the second layer (L2) provides a service to the Radio Link Control (RLC) layer, which is an upper layer thereof, through a logical channel. Also, the MAC layer provides a function of mapping between a logical channel and a transport channel; and multiplexing/demultiplexing a MAC Service Data Unit (SDU) belonging to the logical channel to the transport block, which is provided to a physical channel on the transport channel.

The RLC layer of the second layer (L2) supports reliable data transmission. The function of the RLC layer includes concatenation, segmentation, reassembly of the RLC SDU, and so on. To satisfy varying Quality of Service (QoS) requested by a Radio Bearer (RB), the RLC layer provides three operation modes: Transparent Mode (TM), Unacknowledged Mode (UM), and Acknowledge Mode (AM). The AM RLC provides error correction through Automatic Repeat reQuest (ARQ). Meanwhile, in case the MAC layer performs the RLC function, the RLC layer can be incorporated into the MAC layer as a functional block.

The Packet Data Convergence Protocol (PDCP) layer of the second layer (L2) performs the function of delivering, header compression, ciphering of user data in the user plane, and so on. Header compression refers to the function of reducing the size of the Internet Protocol (IP) packet header which is relatively large and contains unnecessary control to efficiently transmit IP packets such as the lPv4 (Internet Protocol version 4) or IPv6 (Internet Protocol version 6) packets through a radio interface with narrow bandwidth. The function of the PDCP layer in the control plane includes delivering control plane data and ciphering/integrity protection.

The Radio Resource Control (RRC) layer in the lowest part of the third layer (L3) is defined only in the control plane. The RRC layer performs the role of controlling radio resources between the UE and the network. To this purpose, the UE and the network exchange RRC messages through the RRC layer. The RRC layer controls a logical channel, transport channel, and physical channel with respect to configuration, re-configuration, and release of radio bearers. A radio bearer refers to a logical path that the second layer (L2) provides for data transmission between the UE and the network. Configuring a radio bearer indicates that characteristics of a radio protocol layer and channel are defined to provide specific services; and each individual parameter and operating methods thereof are determined. Radio bearers can be divided into Signaling Radio Bearers (SRBs) and Data RBs (DRBs). An SRB is used as a path for transmitting an RRC message in the control plane, while a DRB is used as a path for transmitting user data in the user plane.

The Non-Access Stratum (NAS) layer in the upper of the RRC layer performs the function of session management, mobility management, and so on.

A cell constituting the base station is set to one of 1.25, 2.5, 5, 10, and 20 MHz bandwidth, providing downlink or uplink transmission services to a plurality of UEs. Different cells can be set to different bandwidths.

Downlink transport channels transmitting data from a network to a UE include a Broadcast Channel (BCH) transmitting system information, PCH transmitting paging messages, DL-SCH transmitting user traffic or control messages, and so on. Traffic or a control message of a downlink multi-cast or broadcast service can be transmitted through the DL-SCH or through a separate downlink Multicast Channel (MCH). Meanwhile, uplink transport channels transmitting data from a UE to a network include a Random Access Channel (RACH) transmitting the initial control message and a Uplink Shared Channel (UL-SCH) transmitting user traffic or control messages.

Logical channels, which are located above the transport channels and are mapped to the transport channels. The logical channels may be distinguished by control channels for delivering control area information and traffic channels for delivering user area information. The control channels include a Broadcast Control Channel (BCCH), a Paging Control Channel (PCCH), a Common Control Channel (CCCH), a dedicated control channel (DCCH), a Multicast Control Channel (MCCH), and etc. The traffic channels include a dedicated traffic channel (DTCH), and a Multicast Traffic Channel (MTCH), etc. The PCCH is a downlink channel that delivers paging information, and is used when network does not know the cell where a UE belongs. The CCCH is used by a UE that does not have RRC connection with network. The MCCH is a point-to-multipoint downlink channel which is used for delivering Multimedia Broadcast and Multicast Service (MBMS) control information from network to UE. The DCCH is a point-to-point bi-directional channel which is used by a UE that has RRC connection delivering dedicated control information between UE and network. The DTCH is a point-to-point channel which is dedicated to a UE for delivering user information that may be existed in uplink and downlink. The MTCH is a point-to-multipoint downlink channel for delivering traffic data from network to UE.

In case of uplink connection between the logical channel and the transport channel, the DCCH may be mapped to UL-SCH, the DTCH may be mapped to UL-SCH, and the CCCH may be mapped to UL-SCH. In case of downlink connection between the logical channel and the transport channel, the BCCH may be mapped to BCH or DL-SCH, the PCCH may be mapped to PCH, the DCCH may be mapped to DL-SCH, the DTCH may be mapped to DL-SCH, the MCCH may be mapped to MCH, and the MTCH may be mapped to MCH.

FIG. 5 is a diagram schematically exemplifying a structure of physical channel in a wireless communication system to which the present invention can be applied.

Referring to FIG. 5, the physical channel delivers signaling and data through radio resources including one or more subcarriers in frequency domain and one or more symbols in time domain.

One subframe that has a length of 1.0 ms includes a plurality of symbols. A specific symbol (s) of subframe (e.g., the first symbol of subframe) may be used for PDCCH. The PDCCH carries information for resources which are dynamically allocated (e.g., resource block, modulation and coding scheme (MCS), etc.).

Random Access Procedure

Hereinafter, a random access procedure which is provided in a LTE/LTE-A system will be described.

The random access procedure is performed in case that the UE performs an initial access in a RRC idle state without any RRC connection to an eNB, or the UE performs a RRC connection re-establishment procedure, etc.

The LTE/LTE-A system provides both of the contention-based random access procedure that the UE randomly selects to use one preamble in a specific set and the non-contention-based random access procedure that the eNB uses the random access preamble that is allocated to a specific UE.

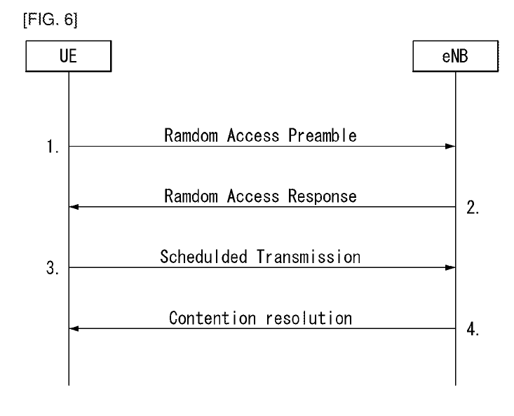

FIG. 6 is a diagram for describing the contention-based random access procedure in the wireless communication system to which the present invention can be applied.

(1) Message 1 (Msg 1)

First, the UE randomly selects one random access preamble (RACH preamble) from the set of the random access preamble that is instructed through system information or handover command, selects and transmits physical RACH (PRACH) resource which is able to transmit the random access preamble.

The eNB that receives the random access preamble from the UE decodes the preamble and acquires RA-RNTI. The RA-RNTI associated with the PRACH to which the random access preamble is transmitted is determined according to the time-frequency resource of the random access preamble that is transmitted by the corresponding UE.

(2) Message 2 (Msg 2)

The eNB transmits the random access response that is addressed to RA-RNTI that is acquired through the preamble on the Msg 1 to the UE. The random access response may include RA preamble index/identifier, UL grant that informs the UL radio resource, temporary cell RNTI (TC-RNTI), and time alignment command (TAC). The TAC is the information indicating a time synchronization value that is transmitted by the eNB in order to keep the UL time alignment. The UE renews the UL transmission timing using the time synchronization value. On the renewal of the time synchronization value, the UE renews or restarts the time alignment timer. The UL grant includes the UL resource allocation that is used for transmission of the scheduling message to be described later (Message 3) and the transmit power command (TPC). The TCP is used for determination of the transmission power for the scheduled PUSCH.

The UE, after transmitting the random access preamble, tries to receive the random access response of its own within the random access response window that is instructed by the eNB with system information or handover command, detects the PDCCH masked with RA-RNTI that corresponds to PRACH, and receives the PDSCH that is indicated by the detected PDOCH. The random access response information may be transmitted in a MAC packet data unit and the MAC PDU may be delivered through PDSCH.

The UE terminates monitoring of the random access response if successfully receiving the random access response having the random access preamble index/identifier same as the random access preamble that is transmitted to the eNB. Meanwhile, if the random access response message has not been received until the random access response window is terminated, or if not received a valid random access response having the random access preamble index same as the random access preamble that is transmitted to the eNB, it is considered that the receipt of random access response is failed, and after that, the UE may perform the retransmission of preamble.

(3) Message 3 (Msg 3)

In case that the UE receives the random access response that is effective with the UE itself, the UE processes the information included in the random access response respectively. That is, the UE applies TAC and stores TC-RNTI. Also, by using UL grant, the UE transmits the data stored in the buffer of UE or the data newly generated to the eNB.

In case of the initial access of UE, the RRC connection request that is delivered through CCCH after generating in RRC layer may be transmitted with being included in the message 3. In case of the RRC connection reestablishment procedure, the RRC connection reestablishment request that is delivered through CCCH after generating in RAC layer may be transmitted with being included in the message 3. Additionally, NAS access request message may be included.

The message 3 should include the identifier of UE. There are two ways how to include the identifier of UE. The first method is that the UE transmits the cell RNTI (C-RNTI) of its own through the UL transmission signal corresponding to the UL grant, if the UE has a valid C-RNTI that is already allocated by the corresponding cell before the random access procedure. Meanwhile, if the UE has not been allocated a valid C-RNTI before the random access procedure, the UE transmits including unique identifier of its own (for example, S-TMSI or random number). Normally the above unique identifier is longer that C-RNTI.

If transmitting the data corresponding to the UL grant, the UE initiates a contention resolution timer.

(4) Message 4 (Msg 4)

The eNB, in case of receiving the C-RNTI of corresponding UE through the message 3 from the UE, transmits the message 4 to the UE by using the received C-RNTI. Meanwhile, in case of receiving the unique identifier (that is, S-TMSI or random number) through the message 3 from the UE, the eNB transmits the 4 message to the UE by using the TC-RNTI that is allocated from the random access response to the corresponding UE. For example, the 4 message may include the RRC connection setup message.

The UE waits for the instruction of eNB for collision resolution after transmitting the data including the identifier of its own through the UL grant included the random access response. That is, the UE attempts the receipt of PDCCH in order to receive a specific message. There are two ways how to receive the PDCCH. As previously mentioned, in case that the message 3 transmitted in response to the UL grant includes C-RNTI as an identifier of its own, the UE attempts the receipt of PDCCH using the C-RNTI of itself, and in case that the above identifier is the unique identifier (that is, S-TMSI or random number), the UE tries to receive PDCCH using the TC-RNTI that is included in the random access response. After that, in the former case, if the PDCCH is received through the C-RNTI of its own before the contention resolution timer is terminated, the UE determines that the random access procedure is performed and terminates the procedure. In the latter case, if the PDCCH is received through the TC-RNTI before the contention resolution timer is terminated, the UE checks on the data that is delivered by PDSCH, which is addressed by the PDCCH. If the content of the data includes the unique identifier of its own, the UE terminates the random access procedure determining that a normal procedure has been performed. The UE acquires C-RNTI through the 4 message, and after that, the UE and network are to transmit and receive a UE-specific message by using the C-RNTI.

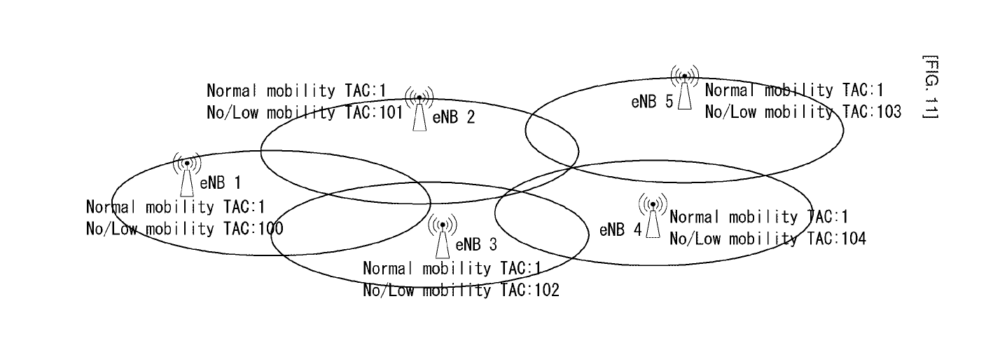

Meanwhile, the operation of the non-contention-based random access procedure, unlike the contention-based random access procedure illustrated in FIG. 11, is terminated with the transmission of message 1 and message 2 only. However, the UE is going to be allocated a random access preamble from the eNB before transmitting the random access preamble to the eNB as the message 1. And the UE transmits the allocated random access preamble to the eNB as the message 1, and terminates the random access procedure by receiving the random access response from the eNB.

Power Saving Mode

The Power Saving Mode (PSM) is a function to minimize power consumption of the UE by defining an interval in which one UE disables access stratum (AS) operations including paging reception and mobility management as one of 3GPP release-12 (rel-12) advanced MTC (enhancements for MTC) (MTCe)) features. That is, the UE that supports the PSM agrees or receives an active time and a periodic TAU timer (P-TAU) with or from the network during attach and tracking area update (TAU).

When receiving the Active Time value from the network, in the case where the UE is switched from ECM-CONNECTED to ECM-IDLE, the UE maintains the ECM-IDLE state to receive the paging during the corresponding Active Time. Then, when the Active Time expires, the UE enters the PSM and stops all Access Stratum (AS) operations.

In addition, the MME starts an active timer with the Active Time value every time the UE enters the ECM-IDLE mode. In addition, when the active timer expires, the MME deduces that the UE is unreachable.

That is, Active Time refers to a time when the UE supporting a state (for example, the power saving mode (PSM), etc.) using a power saving function maintains the ECM-IDLE (or RRC_IDLE) state.

When the periodic TAU timer expires, the UE enables the AS operation and performs the TAU again and the network stops an implicit detach timer of the corresponding UE. The UE may wake up at any time when a user wants for a mobile originated call (e.g., uplink data packet transfer), etc.

On the contrary, for a mobile terminated call (e.g., downlink data packet receiving), etc., the UE wakes up every P-TAU period to perform the TAU and performs a paging receiving operation for the active time received at that time and thereafter, enters the PSM again to sleep.

Discontinuous Reception (DRX) Mode

In the 3GPP LTE/LTE-A system, an EPS connection management (ECM)-connected state and the ECM-IDLE state are defined in order to manage the signaling connection between the UE and the network. The ECM connected state and the ECM idle state may also be applied to the UE and the MME. The ECM connection is comprised of the RRC connection established between the UE and the eNB and the S1 signaling connection established between the eNB and the MME. The RRC state indicates whether the RRC layer of the UE and the RRC layer of the eNB are logically connected. That is, when the RRC layer of the UE and the RRC layer of the eNB are connected, the UE is in the RRC_CONNECTED state. When the RRC layer of the UE and the RRC layer of the eNB are not connected, the UE is in the RRC_IDLE state.

Herein, the RRC_CONNECTED state means a state in which the UE may receive a service on a cell basis while the UE is connected to a specific cell and the UE is managed on the cell basis.

In the RRC_IDLE state, the UE is managed by the unit of a tracking area (TA), which is a larger area unit than the cell in a state in which the UE has no connection with the eNB and only maintains a connection with the Mobility Management Entity (MME). That is, the UE in the RRC_IDLE state intermittently wakes up to monitor a paging channel (PCH) to check whether there is a paging message transmitted to the UE. That is, the UE performs discontinuous reception (DRX) set by a non-access stratum (NAS) using an ID uniquely allocated in the tracking area. The UE may receive broadcasts of system information and paging information by monitoring the paging signal at a specific paging time for each UE-specific paging DRX cycle. In addition, the UE checks whether a reception signal and when the identifier of the UE is included in the paging channel, the UE is switched to the RRC_CONNECTE mode through the service request procedure. Through such a network state definition, UE without an enabled service may minimizes power consumption thereof and the eNB may efficiently use the resources.

As described above, in order for the UE to receive A normal mobile communication service such as voice or data, the UE needs to transit to the ECM connected state. The initial UE is in the ECM idle state as in the case where the UE is first turned on and when the UE is successfully registered in the corresponding network through the initial attach procedure, the UE and the MME transit to the ECM connected state. Further, when the UE is registered in the network but the traffic is inactivated and the radio resource is not thus allocated, the UE is in the ECM idle state and when new uplink or downlink traffic is generated in the UE, the UE and the MME transit to the ECM connected state.

The 3GPP LTE/LTE-A system uses a discontinuous reception (DRX) technique of the UE in order to minimize the power.

The DRX defined in the 3GPP LTE/LTE-A system may be used both in the dormant mode and in the RRC_IDLE state of the UE.

The UE may perform monitoring of the PDCCH based on RNTI (e.g., C-RNTI, SI-RNTI, P-RNTI, etc.) which is a unique identifier of the UE.

The monitoring of the PDCCH may be controlled by the DRX operation and the parameter related to the DRX is transmitted to the UE by the RRC message. When the DRX parameter is configured in the state where the UE is the RRC connected state, the UE performs discontinuous monitoring of the PDCCH based on the DRX operation. On the contrary, when the DRX parameter is not configured, the UE performs continuous PDCCH monitoring.

Further, as described above, the UE receiving the paging message may perform the DRX for the purpose of reducing the power consumption.

To this end, the network configures a plurality of paging occasions for each time cycle called a paging cycle and a specific UE receives the paging message only at a specific paging time, and the UE does not receive the paging channel at occasions other than the specific paging occasion. Further, one paging occasion may correspond to one TTI.

The extended idle mode DRX (eDRX: extended DRX) increases the existing maximum 2.56 s paging DRX cycle to several minutes to several tens of minutes to minimize the power consumption of the UE. The eDRX may be applied to the idle mode and the connected mode. The extended idle mode DRX applied to the connected mode is relatively shorter than the DRX applied in the idle mode, such as up to 10.24 s.

In the case of the UE supporting the eDRX mode, an unreachable state of the UE may mean an unreachable state (i.e., a DRX period in which the UE does not monitor the paging channel) due to paging.

On the contrary, in the case of the UE supporting the eDRX mode, a state in which the UE is reachable may mean the ECM-CONNECTED mode and/or a state in which the UE is immediately reachable by paging (i.e., a period in which the UE monitors the paging channel).

In other words, it may be determined that the eDRX is temporarily unreachable even the idle period because the eDRX period is relatively longer than the normal DRX period. In other words, data may be delivered up to 2.56 seconds after normal DRX (2.56 seconds) is supported, but when the eDRX (e.g., 10 minutes) is applied, the maximum delay is 10 minutes, and as a result, immediate data delivery is unavailable and the unavailable data delivery may be regarded as substantially unreachable.

The UE and the network may negotiate the use of the extended idle mode DRX through NAS signaling to reduce the power consumption of the UE. The UE applying the extended idle mode DRX may use mobile terminating data and/or a network originated procedure within a delay of a specific time depending on the DRX cycle value.

The UE that desires to use the extended idle mode DRX (in particular, a UE side application) needs to specially control a mobile terminating service or data delivery and in particular, the corresponding UE needs to consider delay tolerance of the mobile terminating data. The network (in particular, a network side application) may transmit the mobile terminating data, SMS or device trigger and needs to know whether the extended idle mode DRX is ready. The UE needs to the extended idle mode DRX only in the case where all expected mobile terminating communication is tolerant to the delay.

In order to negotiate the use of the extended idle mode DRX, the UE requests extended idle mode DRX parameters during the Attach procedure and the RAU/TAU procedure. The SGSN/MME may reject or accept the request of the UE for the extended idle mode DRX. When the SGSN/MME accepts the extended idle mode DRX, the SGSN/MME may provide a value different from the extended idle mode DRX parameter requested by the UE based on an operator policy. When the SGSN/MME accepts the use of the extended idle mode DRX, the UE applies the extended idle mode DRX based on the received extended idle mode DRX parameters. When the SGSN/MME rejects the request or when the UE does not receive the extended idle mode DRX parameter within the associated accept message due to reception of the request by the SGSN/MME which does not support he extended idle mode DRX, the UE applies the existing DRX.

When the UE requests both the power saving mode (PSM) (active time and/or periodic TAU timer (T-PAU) request) and the extended idle mode DRX through the NAS, the SGSN/MME may make a determination as follows.

Enabling the PSM only (i.e., rejecting the request for the extended idle mode DRX)

Enabling the extended idle mode DRX only (i.e., rejecting the request for the active time)

Enabling both the PSM (i.e., providing the active time) and the extended idle mode DRX (i.e., providing the extended idle mode DRX parameters)

When one of the three is determined and the associated parameters (i.e., active time, P-TAU timer, and/or extended idle mode DRX cycle value) are provided to the terminal, the next Attach or RAU/TAU procedure is initiated and is used until any one of the three is newly determined. If both the extended idle mode DRX and the PSM are enabled, the extended idle mode DRX cycle may be set to have the plurality of paging occasions while the active timer is driven.

If the PSM active time provided by the UE is greater than the extended idle mode DRX cycle, the SGSN/MME may enable both the PSM and the extended idle mode DRX. This may minimize the power consumption of the UE during the active time.

Machine-Type Communication (MTC)

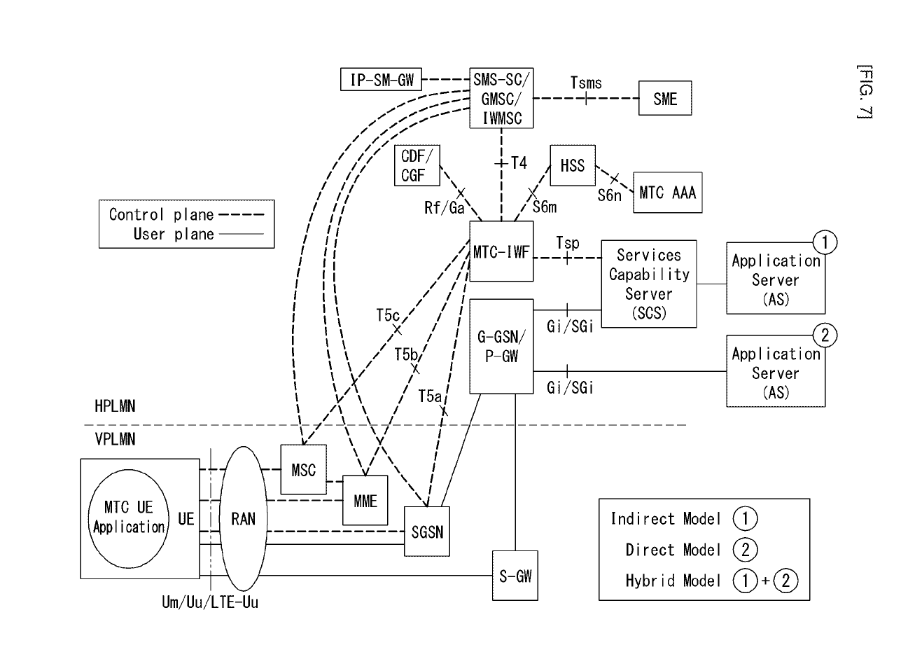

FIG. 7 is a diagram exemplifying a machine-type communication (MTC) architecture in a wireless communication system to which the present invention can be applied.

An end-to-end application between the UE (or MTC UE) used for the MTC and an MTC application may adopt services provided in the 3GPP system and the optional services provided to an MTC server. The 3GPP system may provide transport and communication services (including 3GPP bearer services, IMS, and SMS) including various optimizations to facilitate the MTC.

FIG. 7 illustrates that the UE used for the MTC is connected to a 3GPP network (UTRAN, E-UTRAN, GERAN, I-WLAN, etc.) through an Um/Uu/LTE-Uu interface. The architecture of FIG. 7 includes various MTC models (Direct, Indirect, and Hybrid models).

First, entities illustrated in FIG. 7 will be described.

In FIG. 7, the application server is a server on the network where the MTC application is executed. Techniques for implementing various MTC applications described above may be applied to the MTC application server and a detailed description thereof will be omitted. Further, in FIG. 7, the MTC application server may access the MTC server through a reference point API, and a detailed description thereof will be omitted. Alternatively, the MTC application server may be collocated with the MTC server.

The MTC server (e.g., an SCS server in FIG. 7) is a server on the network that manages the MTC terminal and may communicate with the UE and PLMN nodes connected to the 3GPP network and used for the MTC.

An MTC-interworking function (MTC-IWF) may manage interworking between the MTC server and an operator core network and act as a proxy for the MTC operation. In order to support an MTC indirect or hybrid model, the MTC-IWF may relay or interpret a signaling protocol on a reference point Tsp to enable a specific function in the PLMN. The MTC-IWF performs a function of authenticating the MTC server before the MTC server establishes communication with the 3GPP network, a function of authenticating a control plane request from the MTC server, various functions related to a trigger instruction described later, etc.

Short Message Service-Service Center (SMS-SC)/Internet Protocol Short Message GateWay (IP-SM-GW) may manage transmission and reception of the short message service (SMS). The SMS-SC may be responsible for relaying, storing, and delivering short messages between a short message entity (SME) (an entity transmitting or receiving short messages) and the UE. The IP-SM-GW may take charge of protocol interoperability between a IP-based UE and the SMS-SC.

Charging data function (CDF)/charging gateway function (CGF) may perform charging-related operations.

The HLR/HSS may serve to store subscriber information (IMSI, etc.), routing information, configuration information, etc., and provide the subscriber information (IMSI, etc.), routing information, configuration information, etc., to the MTC-IWF.

The MSC/SGSN/MME may perform control functions including mobility management, authentication, resource allocation, etc., for network connection of the UE. The MSC/SGSN/MME may perform a function of receiving the trigger instruction from the MTC-IWF and processing the received trigger instruction in the form of the message to be provided to the MTC UE in association with the triggering described later.

The gateway GPRS support node (GGSN)/serving-gateway (S-GW)+packet date network-gateway (P-GW) may perform a gateway function of taking charge of connection between a core network and an external network.

In Table 2, main reference points in FIG. 7 are summarized.

TABLE 2

| Refer- | |
|---|---|
| ence | |
| point | Description |
| Tsms | Reference point used for an entity outside the 3GPP system to |
| | communicate with the MTC UE via the SMS |
| Tsp | Reference point used for the entity outside the 3GPP system to |
| | communicate with the MTC-IWF in association with control |
| | plane signaling |
| T4 | Reference point used by the MTC-IWF to route device triggers |
| | to the SMS-SC of the HPLMN |
| T5a | Reference point between the MTC-IWF and a serving SGSN |
| T5b | Reference point between the MTC-IWF and a serving MME |
| T5c | Reference point between the MTC-IWF and a serving MSC |
| S6m | Reference point used by the MTC-IWF to inquire identification |
| | information (E.164 Mobile Station International Subscriber |
| | Directory Number (MSISDN) or IMSI mapped to an external |
| | identifier) of the UE and to collect UE accessibility and |
| | configuration information |

In Table 2, at least one of the reference points T5a, T5b, and T5c is referred to as T5.

Meanwhile, user plane communication with the MTC server in the case of the indirect and hybrid models and communication with the MTC application server in the case of the direct and hybrid models may be performed using the existing protocol through the reference points Gi and SGi.

Specific details related to the contents described in FIG. 7 may be incorporated into the present document by reference of 3GPP TS 23.682 document.

FIG. 8 exemplifies an architecture for service capability exposure in a wireless communication system to which the present invention can be applied.

The architecture for the service capability exposure illustrated in FIG. 8 illustrates that the 3GPP network securely exposes services and capabilities thereof provided by the 3GPP network interface to an external third party service provider application.

A service capability exposure function (SCEF) is a core entity within the 3GPP architecture for the service capability exposure that provides a means for securely exposing the services and capabilities provided by 3GPP network interface. In other words, the SCEF is a key entity for providing service functions belonging to a trust domain operated by a mobile communication provider. The SCEF provides API interfaces to third party service providers and provides 3GPP service functions to third party service providers through connections with various entities of 3GPP. The SCEF may be provided by the SCS.

When a Tsp function may be exposed through the application program interface (API), the MTC-IWF may be co-located with the SCEF. A protocol (e.g., DIAMETER, RESTful APIs, XML over HTTP, etc.) is selected to specify a new 3GPP interface depending on multiple factors and herein, the multiple factors include facilitation of exposure of requested information, and need of a specific interface, but is not limited thereto.

Tracking Area Identity (TAI)

The UE receives a Tracking Area Identity (TAI) list from the MME through Attach and Tracking Area Update (TAU). Whenever the serving cell is changed, the UE performs the TAU when a tracking area code (TAC) (and/or TAI) of the changed cell does not belong to the TAI list of the UE.

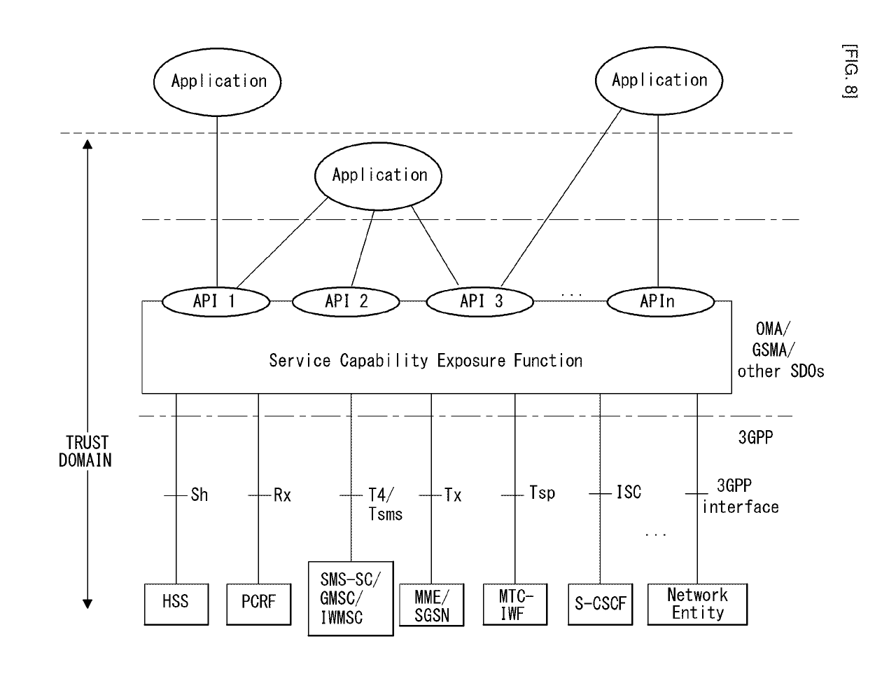

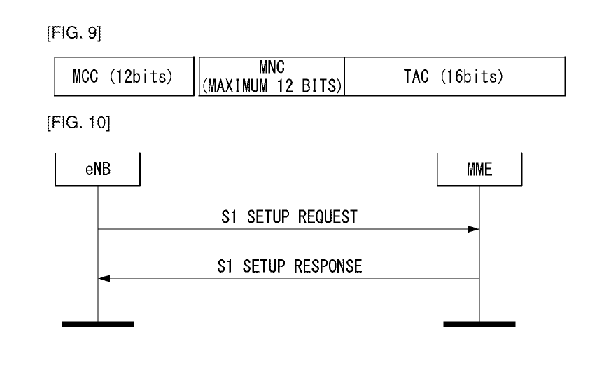

FIG. 9 is a diagram exemplifying a tracking area identifier in a wireless communication system to which the present invention can be applied.

The TAI is the identity used to identify tracking areas. The TAI is constituted by a mobile country code (MCC), a mobile network code (MNC), and a tracking area code (TAC). The PLMN identity may be constituted by the MCC and the MNC.

The TAI is associated with a single time zone. All TAIs serviced by one base station needs to be included in the same time zone.

When the serving cell is changed, the RRC layer of the UE acquires the system information transmitted from the eNB. Then, system information block type 1 (SIB1) is read to transfer the tracking area code is transmitted to a higher layer.

The relationship between the TAI and the TAC is as follows. The cell/eNB belongs to one TAC and the TAC/TAI may be comprised of one or more cells.

The cell broadcasts only one TAI/TAC. A mapping relationship between the corresponding TAI/TAC and the eNB/cell is defined as operation and maintenance (O & M) and recognized by MME.

An operator may configure/provision the tracking area (TA) by operation & management (O&M). In other words, which cell (or eNB) is mapped to which TAC may be previously assigned by the operator.

FIG. 10 is a diagram showing an S1 setup process in a wireless communication system to which the present invention may be applied.

The S1 setup procedure is a procedure for exchanging application level data required to correctly interoperate on an S1 interface between the eNB and the MME.

Referring to FIG. 10, the eNB initiates the S1 setup procedure by transmitting an S1 Setup Request message to the MME.

The S1 Setup Request message may include a global eNB ID, an eNB name, supported TA(s), and the like. The supported TA(s) may include a TAC assigned to the eNB.

The MME transmits an S1 Setup Response message to the eNB in response to the S1 Setup Request message.

As described above, when the eNB establishes the S1 setup (S1 setup) with the MME, the eNB provides the assigned TAC to the MME and, based on this, the MME may recognize to which TA the eNB connected to the MME belongs.

Cellular Internet of Things (IoT) (CIoT)

Cellular IoT (CIoT) refers to IoT using cellular wireless communication technology (e.g., 3GPP technology). In addition, CIoT RAT means radio access technology supporting the CIoT.

The evolution of an radio access network (RAN) and the evolution of a core network (CN) for CIoT services are discussed together.

In the case of the RAN, two types of CIoTs are discussed. One of them is a GERAN evolutionary solution (e.g., Extended Coverage-GSM (EC-GSM)) and the other one which is a new radio access network type called Clean Slate solution (e.g., Narrow Band CIoT or NB-LTE) is discussed.

CIoT EPS optimization supports enhanced small data transfer. One optimization is based on User Plane transport of user data and is referred to as user plane CIoT EPS optimization. In another optimization known as Control Plane CIoT EPS Optimization, the user data is encapsulated to an NAS packet data unit (PDU) to transfer the user data through the MME, and as a result, the total number of control plane messages may be reduced at the time of controlling short data transaction. CIoT data includes, for example, status information, measurement data, and the like generated from the M2M application.

The CIoT EPS Optimization is designed to support both Narrow Band (NB)-IoT RAT and MTC Category M1, but may separately handle individual RATs. That is, the MME; NAS may perform different processing through which RAT the UE is serviced.

In 3GPP, a key issue for paging optimization for the CIoT UE is being accepted and discussed as described below.

3GPP SA2 is discussing paging optimization issues due to scarce of radio interface resources and coder network interface resources associated with the no mobile/low mobility device. Therefore, in order to reduce paging resources for both the radio interface and the core network interference, the availability of paging is being discussed only in the most recently used eNB/cell, not all cells in the tracking area (TA).

The issue of scare of paging resource is more serious for the CIoT due to the following reasons.

The number of CIoT devices is even larger than that of legacy cellular devices in a given area.

Narrow band CIoT radio access technology (RAT) may not support the sufficient paging resources and UE identifiers (e.g., S-TMST, IMSI, etc.) included in a single paging message may be significantly limited due to a small message size in contrast to a legacy access system (e.g., E-UTRAN).

Since the coverage enhancement is a mandatory requirement, each paging message may occupy a long period of time (e.g., repetition of the same paging message).

The advantage of the CIoT device is that the CIoT device may have no mobility/low mobility characteristics. Therefore, limiting the paging area to the cell(s) rather than paging to all eNB(s)/cell(s) in the tracking area may be more suitable and beneficial in terms of reducing the paging resources.

However, the last known cell that informs the MME when the UE enters the idle mode may not be accurate in the case of the stationary CIoT device. The serving cell may be changed even though the UE does not move due to various reasons such as a change in radio load state and a change in surrounding state (i.e., blocking by a new building).

Further, since the low mobility UE will not move over a large area of coverage within a given time period, the limited paging area will benefit both the no mobility UE(s) as well as the low mobility UE(s). Therefore, paging area management for limiting to small paging areas requires paging optimization for the CIoT device.

To this end, the following architectural requirements for the paging area management need to be satisfied. The system needs to support an efficient paging area management procedure for the no/low mobility UE.

The system needs to consider a change in dynamic environment radio condition even in the case of the no mobility UE.

The system needs to consider that the CIoT UE does not perform measurement reporting to the CIoT RAT.

The system needs to consider that frequent signaling exchanges are prevented.

Method for Managing Plurality of Paging areas/Location Areas

As described above in the key issue, there is a need for an effective method for managing the paging area for the CIoT UE. In particular, it is necessary to distinguish the UE having a no mobility characteristic from the UE having a mobility characteristic and operate the paging area.

In order to operate the paging area at a cell level (or cell unit) in the no mobility UE, a tracking area identity (TAI) may be operated to be small by the unit of the cell. Therefore, when the cell is changed, the UE performs Tracking Area Update (TAU) so that the core network may recognize the mobility of the UE by the unit of the cell. However, in the case of a UE designed for tracking logistics, the TAU may be triggered at every cell change, which may cause serious power consumption. Accordingly, the UE having the mobility may provide a TAI list including a large number of TAIs, but since a message size is small due to the CIoT characteristic, inconvenience of operation or burden of data resources results in an inefficient operation.

To solve the problem, the present invention proposes a method for more efficiently the paging area/location area.

Hereinafter, the tracking area (TA) will be mainly described for convenience of description, but the present invention is not limited thereto. The present invention may be applied to any location area (location area (LA)) defined for managing the location of the terminal, such as a routing area (RA).

According to an embodiment of the present invention, a plurality of (or a plurality of types) TAs may be operated. Then, the UE may be configured with any one tracking area according to the mobility characteristic of the UE (i.e., whether the UE is a normal mobility UE or a no/low mobility UE).

Hereinafter, in the specification, the TAC (or TA) used by the normal mobility UE will be referred to as a normal mobility TAC (or a general mobility TA) and the TAC (or TA) used by the no/low mobility UE will be referred to as a no/low mobility TAC (or no/low mobility TA). However, the present invention is not limited to such a name, and the normal mobility TAC may be called a wide/large tracking area or a normal tracking area, and the low mobility TAC (no/low mobility TAC) may be called a name such as a small tracking area, or the like.

That is, the tracking area may be operated a first TA as one cell (or base station) or a relatively narrow range configured to be suitable for the no mobility/low mobility UE, and a second TA as a plurality of cells (or base stations) or a wider range configured to be suitable for a UE having normal mobility. In addition, this is only one example and in some cases, the tracking area may be operated as two or more (i.e., two or more types of) TAs. In other words, two tracking areas such as the Wide/Large Tracking Area and the Small Tracking Area may be more subdivided and operated into the Wide Tracking Area, a Middle Tracking Area, the small tracking area, and the like.

FIG. 11 is a diagram showing a multi-type tracking area according to an embodiment of the present invention.

FIG. 11 illustrates an example in which two types of tracking areas are operated.

Referring to FIG. 11, the eNB 1 belongs to #1 as a normal mobility TAC and belongs to #100 as no/low mobility TAC. The eNB 2 belongs to #1 as the normal mobility TAC and belongs to #101 as the no/low mobility TAC. The eNB 3 belongs to #1 as the normal mobility TAC and belongs to #102 as the no/low mobility TAC. The eNB 4 belongs to #1 as the normal mobility TAC and belongs to #104 as the no/low mobility TAC. The eNB 5 belongs to #1 as the normal mobility TAC and belongs to #103 as the no/low mobility TAC.

That is, normal mobility TAC 1 comprises 5 cells (or base stations) and each of no/low mobility TACs 100 to 104 comprises by one cell (or base station).

Each eNB broadcasts the normal mobility TAC and the no/low mobility TAC. In this case, the normal mobility TAC and the nollow mobility TAC may be transmitted through system information block type 1.

The UE determines whether to perform the TAU procedure using only one TAC of two types of TACs according to the mobility characteristics thereof.

For example, UE A may be configured as normal mobility UE from the network by determination of an MME/control plane (CP) function based on mobility information provided by the UE to the network, UE subscription information of the HSS, and/or mobility history information of the UE which the MME receives from the eNB. For example, UE A as the normal mobility UE may be used for tracking the distribution among the MTC UEs.

UE A may receive two types of TACs (i.e., normal mobility TAC and no/low mobility TAC) broadcasted from the base station. In other words, when UE A is in an ECM-CONNECTED state, UE A may perform handover to an adjacent cell (or base station) and receive a message (i.e., including multiple types of TACs) broadcasted from the adjacent cell (or base station). Further, when UE A is in an ECM-IDLE state, UE A may perform cell reselection to the adjacent cell (or base station) and receive a message (i.e., including multiple types of TACs) broadcasted from the adjacent cell (or base station). In addition, UE A may perform the TAU procedure using only the normal mobility TAC according to the mobility characteristic thereof.

In this case, a lower layer (e.g., an RRC layer) of UE A may inform only the upper layer of the UE of the normal mobility TAC broadcasted from the eNB. In addition, the upper layer of the UE may configure the TA! of the corresponding cell from the PLMN identifiers (i.e., MCC and MNC) and the TACs transferred from the lower layer.

When TAC 1 is included in the tracking area identity (TAI) list of UE A (i.e., when the TAI including TAC 1 is included in the TAI list), the TAU is not triggered while UE A moves among eNBs 1 to 5. That is, UE A may be located anywhere among eNBs 1 to 5 because UE A has the mobility characteristics. On the contrary, when UE A deviates from eNBs 1 to 5, the TAU is triggered. In other words, when UE A moves from eNB 1 to eNB 2 (i.e., due to handover or cell reselection), even though the TAI constituted by the no/low mobility TAC (i.e., changed from 100 to 101) is not included in the TAI list, UE A may not initiate the TAU.

UE A sends a TAU request message when UE A enters an eNB/Cell not belonging to the TAI list held by the UE (i.e., when UE A moves to Normal TAC 2 or 3, not Normal TAC 1 in FIG. 11). In this case, the TAI at which UE A is located is transmitted to the MME in the TAU request message and the MME receives the TAI. Since the TA at which UE A is located is changed, the TAI (i.e., the TAI of the most recent TAU) of UE A is updated. In addition, UE A receives a list of TAIs including TAIs constituted by the normal mobility TAC from the MME through a TAU accept message and compares the list with the list of TAIs thereof and when both lists are different from each other, UE A may update the TAI list.

Thereafter, upon occurrence of a mobile terminated call, the core network may transmit paging to all eNBs 1, 2, 3, 4, and 5 mapped to TAC 1 (when UE A is located within TAC 1 at present) to UE A. That is, when the MME receives a downlink data notification message (DDN: Downlink Data Notification) indicating that there is downlink traffic to be transmitted from the S-GW to UE A, the MME may transmit the paging to all of eNBs 1, 2, 3, 4, and 5 mapped to TAC 1. Accordingly, the paging may be transmitted regardless of where UE A is located in the coverage of eNBs 1 to 5.

On the contrary, UE B may be configured as the no/low mobility UE from the network by determination of an MME/control plane (CP) function based on mobility information provided by the UE to the network, UE subscription information of the HSS, and/or mobility history information of the UE which the MME receives from the eNB. In this case, the mobility may be configured differently even for the same UE according to application characteristics (low mobility, high mobility, etc.).

UE B may receive two types of TACs (i.e., normal mobility TAC and no/low mobility TAC) broadcasted from the base station. In other words, when UE A is in the ECM-CONNECTED state, UE A may perform handover to an adjacent cell (or base station) and receive a message (i.e., including multiple types of TACs) broadcasted from the adjacent cell. Further, when UE B is in an ECM-IDLE state, UE A may perform cell reselection to the adjacent cell (or base station) and receive a message (Le., including multiple types of TACs) broadcasted from the adjacent cell (or base station). In addition, UE B may perform the TAU procedure using only the no/low mobility TAC according to the mobility characteristic thereof.

In this case, the lower layer (e.g., RRC layer) of UE B may inform only the upper layer of the UE of the no/low mobility TAC broadcasted from the eNB. In addition, the upper layer of the UE may configure the TAI of the corresponding cell from the PLMN identifiers (i.e., MCC and MNC) and the TACs transferred from the lower layer.

When TAC 100 or 101 is included in the tracking area identity (TAI) list of UE B (i.e., when the TAI including TAC 100 or 101 is included in the TAI list), the TAU is not triggered while UE B moves among eNBs 1 and 2. On the contrary, when UE B deviates from eNBs 1 and 2, the TAU is triggered. In other words, when UE B moves from eNB 2 to eNB 3 (i.e., due to handover or cell reselection), the TAU may be initiated regardless of whether the TAI constituted by the normal mobility TAC (i.e., 1) is included in the TAI list.

When UE B moves to an eNB which belongs to another TAC other than the TAI list held by the UE, the TAI at which UE B is located is transmitted to the MME in the TAU request message and the MME receives the TAI. Since the TA at which UE B is located is changed, the TAI (i.e., the TAI of the most recent TAU) of UE B is updated. In addition, UE B receives a list of TAIs including TAIs constituted by the no/low mobility TAC from the MME through the TAU accept message and compares the list with the list of TAIs thereof and when both lists are different from each other, UE B may update the TAI list.

UE B, as the no mobility UE, may primarily receive a service from eNB 1 and the serving cell of UE B may be changed to eNB 2 due to a traffic load around eNB 1. However, since there is no case where UE B moves to the eNB 3, 4 or 5 or is serviced from the eNB 3, 4 or 5, the TAU due to the change of the tracking area may hardly occur.

Since the core network recognizes the location of UE B as TAC 100 or 101, i.e., eNB 1 or 2, the core network may transmit the paging only to eNB 1 or 2 when the mobile terminated call occurs. That is, when the MME receives a downlink data notification message (DDN: Downlink Data Notification) indicating that there is downlink traffic to be transmitted from the S-GW to UE B, the MME may transmit the paging to all of eNBs 1 and 2 mapped to TACs 100 and 101. As described above, the paging is transmitted in a relatively small area as compared with the normal mobility terminal, thereby reducing paging resources.

Meanwhile, the TAC type used by the UE may be configured from the network. More specifically, when an Attach procedure and a Location Area Update (e.g., a Tracking Area Update (TAU) or a Routing Area Update (RAU) procedure between the UE and the network, the UE may be configured which type of TAC is to be used from the network.

The HSS may store information indicating whether to use the normal mobility TAC/TA or the no/low mobility TAC/TA as the subscription information. The MME may acquire the UE subscription information from the HSS during the Attach procedure and the Location Area Update procedure and transmit information indicating whether the corresponding UE uses the normal mobility TAC/TA or the no/low mobility TAC/TA to the corresponding UE. For example, the MME may transmit the information to the UE through the Attach Accept message in the Attach procedure or the Location Area Update Accept message in the Location Area Update procedure (e.g., the TAU accept message or RAU accept message). Further, when the MME transmits the TAI list to the UE in the attach accept message or the location area update accept message, the MME may transmit to the UE the TAI list depending on a TAC/TA type indicated by information indicating which TAC/TA type used by the UE is to be used.

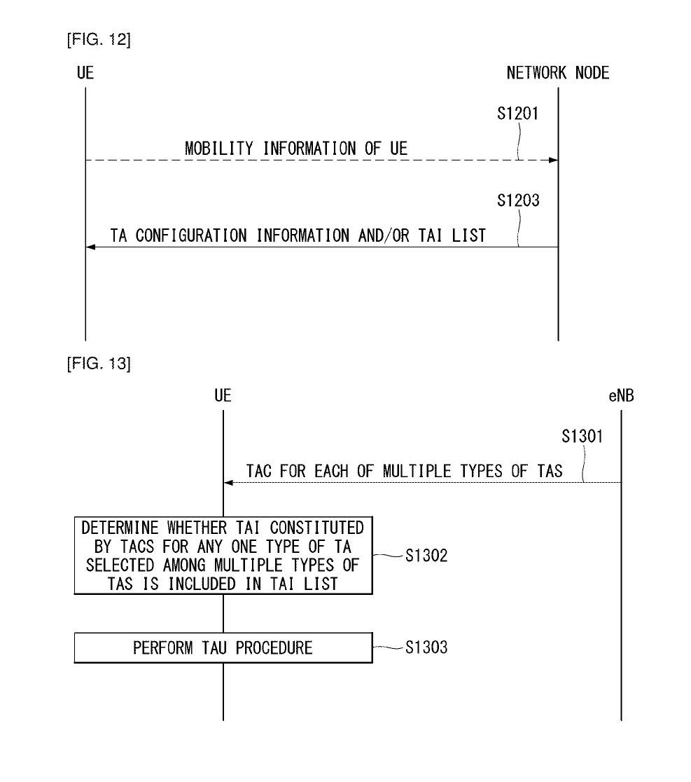

FIG. 12 is a diagram showing a tracking area setup procedure according to an embodiment of the present invention.

Referring to FIG. 12, a UE may receive information (i.e., TA configuration information) indicating which type of TA (or TAC) among multi-type tracking areas (TAs) (or tracking area codes (TACs)) is to be used from a network node (e.g., a base station or an MME) (S1203).

The multi-type TA may include a first TA (i.e., TA/TAC applied to the normal mobility UE) constituted by a plurality of cells and a second TA (i.e., a no/low mobility UE) which is in a relatively smaller range than the first TA.

Herein, the TA configuration information may be stored in a home subscriber server (HSS) as subscription information. In addition, among the attach procedure and/or the TAU procedure, the MME may acquire the TA configuration information stored in the HSS and transmit the TA configuration information to the UE through the attach accept message and/or the TAU accept message.

In this case, whenever the UE performs the attach procedure and/or the TAU, the MME may transmit the TA configuration information to the UE. That is, the MME may transmit the TA configuation information even if the TA configured in the UE is not changed.

On the contrary, the MME may transmit the TA configuration information and thereafter, only when the TA configured in the corresponding UE is changed, the MME may transmit the TA configuration information. For example, the MME may transmit the TA configuration information to the UE only when the mobility characteristic of the corresponding UE is changed to the general mobility TA after configuring the no/low mobility TA to the UE.

Then, the UE may receive the TAI list according to the TA configured in the UE from the network node. That is, during the attach procedure and/or the TAU procedure, the MME acquires the TA configuration information stored in the HSS to confirm the TA configured in the corresponding UE and transmit the TAI list depending on the TA configured in the corresponding UE to the UE. For example, the TAI list may be transmitted to the UE through the attach accept message and/or the TAU accept message.

As described above, when the TA configuration information is transmitted to the UE every time the attach procedure and/or the TAU is performed, the TA configuratino information and the TAI list are transmitted may be transmitted to the UE through the attach accept message and/or the TAU accept message.

On the contrary, when the TA configuration information is transmitted only when the TA configured in the UE is changed, in the case where the TA configuration information is transmitted to the UE for the first time, the TA configruation information and the TAI list are transmitted together to the UE through the attach accept message and/or the TAU accept message, but only the TAI list may be then transmitted to the UE through the attach accept message and/or the TAU accept message.

As described above, the TA configured to the UE may be changed as the mobile characteristics. In this case, the HSS may update the TA configuration information according to the TA configured in the UE. Further, the MME may confirm that the TA configured to the corresponding UE is changed by confirming the subscription information (i.e., the updated TA configuration information) stored in the HSS during the attach procedure and/or the TAU procedure.

For example, the mobility of the UE may be determined according to the characteristics of the application operated in the UE, the mobility characteristic of the UE is changed as the application characteristic changed, and as a result, the TA configured to the UE may be changed. In this case, the terminal may notify the network node (for example, the base station or the MME) that the application characteristic in the corresponding terminal has been changed (S1201). In the case of updating the TA configured to the UE itself in the network without informing the network as the mobility characteristic of the UE is changed, step S1201 may not be performed.

For example, the UE may transmit the changed mobility characteristic information to the network, request the change of the TA configuration information, or request the configuration of a specific TA according to the changed mobility characteristic as the characteristic of the application which operates in the UE is changed. The mobility characteristic information may be transferred in the form of various information, but is referred to as the mobility characteristic information of the UE for convenience of description.

For example, when transmitting the TAU request message, in the case where the UE determines that the mobility characteristic of the UE is changed, the UE may transmit the TAU request message including the changed mobility information of the UE to the network node.

As another example, the TA configured to the UE may be determined using the mobility history information of the UE transmitted from the eNB. In this case, in the case where the eNB determines that the mobility of the UE is changed when the UE transmits the TAU request message, when the eNB forwards the TAU request message to the network node, the eNB may transmit the changed mobility information (i.e., mobility history information) to the network node together.

The network node (e.g., the base station or the MME) may confirm that the mobility characteristic of the UE is changed based on the mobility characteristic information received from the UE and/or the mobility history information of the UE received from the eNB. In this case, the network node may update the subscription information (i.e., TA configuration) of the UE stored in the HSS. In addition, the network node may reconfigure the TA of the UE based on the changed mobility information received from the UE, the UE mobility history information received from the eNB and/or the subscription information of the UE updated in the HSS. Further, the network node may transmit the TA configuration information for the TA that is reconfigured as described in step S1203. Moreover, the network node may transmit the TAI list for the reconfigured TA to the UE.

FIG. 13 is a diagram showing a location area update procedure according to an embodiment of the present invention.

Referring to FIG. 13, the UE receives the TAC for each of multi-types of TAs from the base station (S1301).

That is, the ECM-CONNECTED UE performs handover or the ECM-IDLE UE performs cell reselection to receive the TAC for each of the multi-type TAs from a new cell (or base station) which enters. In this case, the TAC for each of multi-types of TAs may be broadcasted from the base station. As an example, the TAC for each of multi-types of TAs may be transmitted through SIB 1.

The UE determines whether the tracking area identity (TAI) comprising TACs for any one TA selected among the multi-types of TAs is included in the TAI list of the UE (S1302).

Herein, in FIG. 12, the TA type indicated by the TA configuration information received from the network node by the UE may be selected.

According to a determination result in step S1302, when the TAI comprising the TACs for any one selected type is not included in the TAI list, the UE may perform the tracking area update (TAU) procedure (S1303).

That is, the UE determines whether only the TAI for the TA configured in the UE is included in the TAI list thereof and when the corresponding TAI is included in the TAI list, the UE does not perform the TAU procedure, but when the corresponding TAI is not included in the TAI list, the UE may perform the TAU procedure. In other words, regardless of whether the TAI for the TA which is not configured in the UE is included in the TAI list of the UE, it is determined whether only the TA configured in the corresponding UE is included in the TAI list to determine whether the TAI procedure is triggered.

In FIG. 13, the case where the UE performs the TAU procedure is illustrated.

More specifically, the UE initiates the TAU procedure by transmitting the TAU request message to the MME. Here, the TAU request message may include a TAI that identifies the TA most recently visited by the UE. In this case, the TA may correspond to a specific type configured (or selected) the corresponding UE.

As described above, when transmitting the TAU request message, in the case where the UE determines that the mobility characteristic of the UE is changed, the UE may transmit the TAU request message including the changed mobility information of the UE to the network node.

Alternatively, in the case where the eNB determines that the mobility of the UE is changed when the UE transmits the TAU request message, when the eNB forwards the TAU request message to the network node, the eNB may transmit the changed mobility information (i.e., mobility history information) to the network node together.

The network node may confirm that the mobility characteristic of the UE is changed based on the mobility characteristic information received from the UE and/or the mobility history information of the UE received from the eNB. In this case, the network node may update the subscription information (i.e., TA configuration) of the UE stored in the HSS. In addition, the network node may reconfigure the TA of the UE based on the changed mobility information received from the UE, the UE mobility history information received from the eNB and/or the subscription information of the UE updated in the HSS.

Then, the UE receives the TAU accept message from the MME in response to the TAU request message. Here, the TAU accept message may include a list of TAIs for identifying the TA which the UE may enter without performing the TAU procedure. In this case, the TA may correspond to a specific type configured (or selected) the corresponding UE.

In addition, when another type of TA is reconfigured in the corresponding UE, the TA configuration information indicating the TA type reconfigured in the UE may be included in the TAU accept message. Then, the TAI list according to the reconfigured TA may be included in the TAU accept message.

As described above, the MME may update the TA of the most recent TAU of the corresponding UE by receiving the TAI at which the corresponding UE is located through the TAU procedure. Thereafter, when downlink data to be transmitted to the corresponding UE is generated (that is, when the MME receives the DDN from the S-GW), the MME may transmit a paging message to each base station belonging to the TA in which the UE is registered. In this case, the TA may correspond to a specific type configured (or selected) the corresponding UE.

On the contrary, according to the determination result in step S1302, when the TAI comprising the TACs for any one selected type is included in the TAI list, the UE may not perform the tracking area update (TAU) procedure.

Overview of Devices to Which the Present Invention Can be Applied

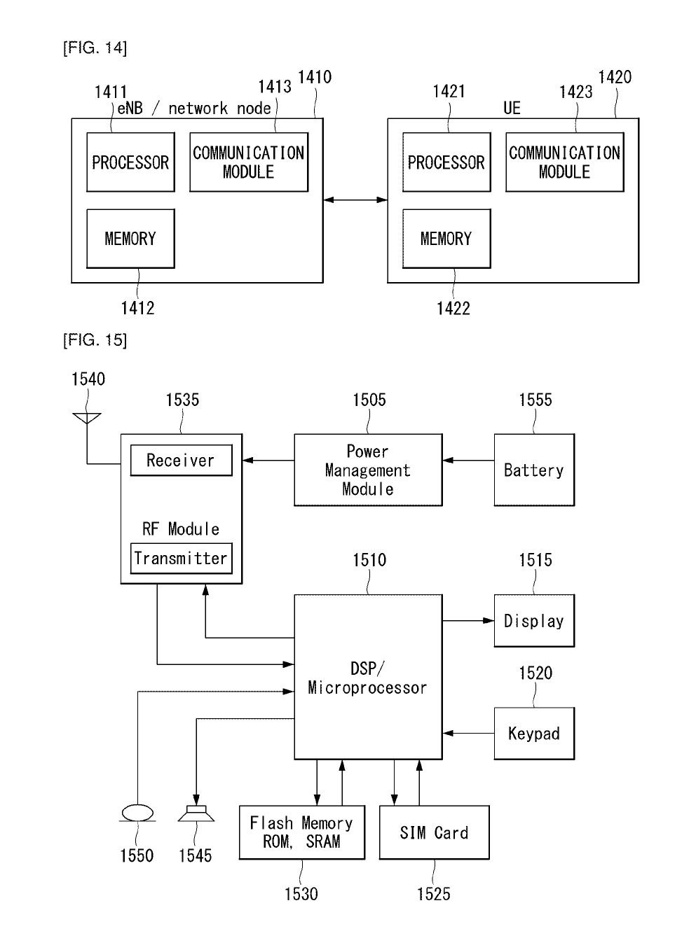

FIG. 14 illustrates a block diagram of a communication device according to one embodiment of the present invention.

With reference to FIG. 14, a wireless communication system comprises a network node 1410 and a plurality of UEs 1420.

A network node 1410 comprises a processor 1411, memory 1412, and communication module 1413. The processor 1411 implements proposed functions, processes and/or methods proposed through FIG. 1 to FIG. 13. The processor 1411 can implement layers of wired/wireless interface protocol. The memory 1412, being connected to the processor 1411, stores various types of information for driving the processor 1411. The communication module 1413, being connected to the processor 1411, transmits and/or receives wired/wireless signals. Examples of the network node 1410 include an eNB, MME, HSS, SGW, PGW, application server and so on. In particular, in case the network node 1410 is an eNB, the communication module 1413 can include a Radio Frequency (RF) unit for transmitting/receiving a radio signal.

The UE 1420 comprises a processor 1421, memory 1422, and communication module (or RF unit) 1423. The processor 1421 implements proposed functions, processes and/or methods proposed through FIG. 1 to FIG. 13. The processor 1421 can implement layers of wired/wireless interface protocol. The memory 1422, being connected to the processor 1421, stores various types of information for driving the processor 1421. The communication module 1423, being connected to the processor 1421, transmits and/or receives wired/wireless signals.

The memory 1412, 1422 can be installed inside or outside the processor 1411, 1421 and can be connected to the processor 1411, 1421 through various well-known means. Also, the network node 1410 (in the case of an eNB) and/or the UE 1420 can have a single antenna or multiple antennas.

FIG. 15 illustrates a block diagram of a wireless communication apparatus according to an embodiment of the present invention.

Particularly, in FIG. 15, the UE described above FIG. 26 will be exemplified in more detail.

Referring to FIG. 15, the UE includes a processor (or digital signal processor) 1510, RF module (RF unit) 1535, power management module 1505, antenna 1540, battery 1555, display 1515, keypad 1520, memory 1530, Subscriber Identification Module (SIM) card 1525 (which may be optional), speaker 1545 and microphone 1550. The UE may include a single antenna or multiple antennas.

The processor 1510 may be configured to implement the functions, procedures and/or methods proposed by the present invention as described in FIG. 1-13. Layers of a wireless interface protocol may be implemented by the processor 1510.

The memory 1530 is connected to the processor 1510 and stores information related to operations of the processor 1510. The memory 1530 may be located inside or outside the processor 1510 and may be connected to the processors 1510 through various well-known means.

A user enters instructional information, such as a telephone number, for example. by pushing the buttons of a keypad 1520 or by voice activation using the microphone 1550. The microprocessor 1510 receives and processes the instructional information to perform the appropriate function, such as to dial the telephone number. Operational data may be retrieved from the SIM card 1525 or the memory module 1530 to perform the function. Furthermore, the processor 1510 may display the instructional and operational information on the display 1515 for the user's reference and convenience.

The RF module 1535 is connected to the processor 1510, transmits and/or receives an RF signal. The processor 1510 issues instructional information to the RE module 1535, to initiate communication, for example, transmits radio signals comprising voice communication data. The RE module 1535 comprises a receiver and a transmitter to receive and transmit radio signals. An antenna 1540 facilitates the transmission and reception of radio signals. Upon receiving radio signals, the RF module 1535 may forward and convert the signals to baseband frequency for processing by the processor 1510. The processed signals would be transformed into audible or readable information outputted via the speaker 1545.

The aforementioned embodiments are achieved by combination of structural elements and features of the present invention in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

The embodiments of the present invention may be achieved by various means, for example, hardware, firmware, software, or a combination thereof. In a hardware configuration, the methods according to the embodiments of the present invention may be achieved by one or more ASICs (Application Specific Integrated Circuits), DSPs (Digital Signal Processors), DSPDs (Digital Signal Processing Devices), PLDs (Programmable Logic Devices), FPGAs (Field Programmable Gate Arrays), processors, controllers, microcontrollers, microprocessors, etc.

In a firmware or software configuration, the embodiments of the present invention may be implemented in the form of a module, a procedure, a function, etc. Software code may be stored in a memory unit and executed by a processor. The memory unit may be located at the interior or exterior of the processor and may transmit data to and receive data from the processor via various known means.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

In a wireless communication system of the present invention, an example in which a location area updating method and/or a paging area managing method are/is applied to a 3GPP LTE/LTE-A system is primarily described, but can be applied to various wireless communication systems in addition to the 3GPP LTE/LTE-A system.

1. A method for performing, by a terminal, a location area update in a wireless communication system, the method comprising:
receiving, from a base station, respective tracking area codes (TAC) for multiple types of tracking areas (TA);
determining whether a tracking area identity (TAI) comprising a TAC of any one type of TA selected from the multiple types of TAs belongs to a TAI list of the terminal; and
if the TAI does not belong to the TAI list, performing a tracking area update (TAU) procedure.

2. The method of claim 1, wherein the multiple types of TAs include a first TA comprising a plurality of cells and a second TA which is in a relatively smaller range than the first TA.

3. The method of claim 1, wherein TA configuration information indicating which type of TA among the multiple types of TAs the terminal is to use is stored in a home subscriber server (HSS).

4. The method of claim 1, further comprising:
receiving TA configuration information indicating which type of TA among the multiple types of TAs to use from a mobility management entity (MME) during an attach procedure and/or a location area update procedure.

5. The method of claim 1, wherein the respective TAC for the multiple types of TAs is broadcasted from the base station.

6. The method of claim 1, wherein the performing of the TAU procedure includes transmitting to the mobility management entity (MME) a tracking area update (TAU) request message including a TAI for identifying the selected one type of TA, which is most recently visited by the terminal.

7. The method of claim 1, wherein the performing of the TAU procedure includes receiving from the mobility management entity (MME) a tracking area update (TAU) accept message including a list of TAIs for identifying the selected one type of TA, which the terminal is capable of entering without performing the TAU procedure.

8. The method of claim 1, wherein when downlink data to be transmitted to the terminal is generated, a paging message is transmitted to each base station which belongs to the selected one type of TA in which the terminal is registered.

9. A terminal for performing location area update in a wireless communication system, the terminal comprising:
a communication module for transmitting/receiving a signal; and
a processor controlling the communication module,
wherein the processor is configured to
receive, from a base station, respective tracking area codes (TAC) for multiple types of tracking areas (TA),
determine whether a tracking area identity (TAI) comprising a TAC of anyone type of TA selected from the multiple types of TAs belongs to a TAI list of the terminal, and
if the TAI does not belong to the TAI list, perform a tracking area update (TAU) procedure.
